(19) United States
(12) Patent Application Publication
(10) Pub. No.: US 2008/0102781 A1
(43) Pub. Date: May 1, 2008

(54) Pin-jointed structure of a mobile electronic device

(75) Inventors: Chung-Kuo Lai, Taipei (TW); Yu-Tsai Chang, Taipei (TW); Ming-Pin Wang, Taipei (TW)

Correspondence Address: John G. Chupa;Law Offices of John Chupa & Associates, P.C., Suite 50, 28535 Orchard Lake Road, Farmington Hills, MI, 48334, US

(73) Assignee: Compal Electronics, Inc.

(21) Appl. No.: 11/704,673

(22) Filed: Feb. 9, 2007

(30) Foreign Application Priority Data
Oct. 25, 2006 (TW) 095139334
Dec. 1, 2006 (TW) 095144651

(51) Int. Cl. H04B 1/03

(52) U.S. Cl. 455/347

(57) ABSTRACT

A pin-jointed structure connected between a cover member and a base member of a mobile electronic device is disclosed to include a pivot holder affixed to the base member, a mounting plate affixed to the cover member and pivoted to the pivot holder, and a spring plate connected between the mounting plate and a boss of the cover member for buffering the drawing force between the pivot holder and the mounting plate to prevent breaking of the boss of the cover member when the cover member is opening from or closing on the base member.

### BACKGROUND OF THE INVENTION

1. Field of the Invention

The present invention relates to a mobile electronic device and more particularly, to a pin-jointed structure provided between the base member and cover member of a mobile electronic device for allowing the cover member to be opened from and then closed on the base member.

2. Description of the Related Art

A mobile electronic device has a pin-jointed structure connected between the base member and cover member thereof. The pin-jointed structure is directly fastened to a plurality of bosses at the cover member and a plurality of bosses at the base member. When opening the cover member from the base member or closing the cover member on the base member, the pin-jointed structure causes a drawing force relative to the cover member, and this drawing force may be concentrated on the bosses, causing the bosses to break.

Therefore, it is desirable to provide a pin-jointed structure that eliminates the aforesaid problem.

### SUMMARY OF THE INVENTION

The present invention has been accomplished under the circumstances in view. It is therefore the main object of the present invention to provide a pin-jointed structure for use in a mobile electronic device to join the cover member and the base member of the mobile electronic device that buffers the drawing force produced upon opening of the cover member from the base member or closing of the cover member on the base member, preventing breaking of the bosses of the mobile electronic device to which the pin-jointed structure is fastened.

According to one embodiment of the present invention, the pin-jointed structure is connected between a cover member and a base member of a mobile electronic device for enabling the cover member to be opened from and closed on the base member, comprising a pivot holder affixed to the base member, a mounting plate affixed to the cover member and pivoted to the pivot holder with pivot means and having a first through hole, and a spring plate mounted on the mounting plate. The spring plate has a first mounting hole for allowing insertion of a screw to be inserted through the first through hole of the mounting plate and fastened to a first boss of the cover member. The first mounting hole of the spring plate has a diameter smaller than the first through hole of the mounting plate.

According to a second embodiment of the present invention, the pin-jointed structure is connected between a cover member and a base member of a mobile electronic device for enabling the cover member to be opened from and closed on the base member, comprising a pivot holder affixed to the base member and a mounting plate affixed to the cover member and pivoted to the pivot holder with pivot means. The mounting plate comprises a first spring plate formed integral with a part thereof. The first spring plate has a mounting hole for the insertion of a screw to be fastened to a first boss of the cover member.

When closing the cover member on the base member or opening the cover member from the base member, the spring plate is curved to disperse or buffer the drawing force between the pivot holder and the mounting plate, avoiding concentration of stress and preventing breaking of the boss of the cover member.

### BRIEF DESCRIPTION OF THE DRAWINGS

FIG. 1 is an elevational view of a mobile electronic device constructed according to a first embodiment of the present invention.

FIG. 2 is an exploded view showing the pin-jointed structure installed in the base member according to the first embodiment of the present invention.

FIG. 3 is an exploded view of the pin-jointed structure according to the first embodiment of the present invention.

FIG. 4 is an exploded view showing two pin-jointed structures symmetrically arranged on the cover member according to the first embodiment of the present invention.

FIG. 5 is a perspective view showing the pin-jointed structure installed in the cover member according to the first embodiment of the present invention.

FIG. 6 is an exploded view of a pin-jointed structure according to a second embodiment of the present invention.

FIG. 7 is a perspective assembly view of the pin-jointed structure according to a second embodiment of the present invention.

FIG. 8 is a perspective assembly view of the second pin-jointed structure according to the second embodiment of the present invention.

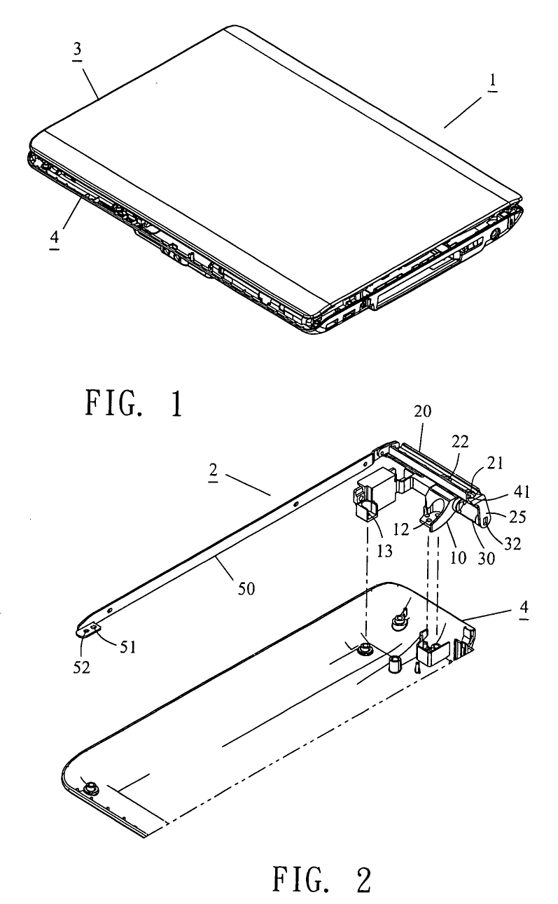

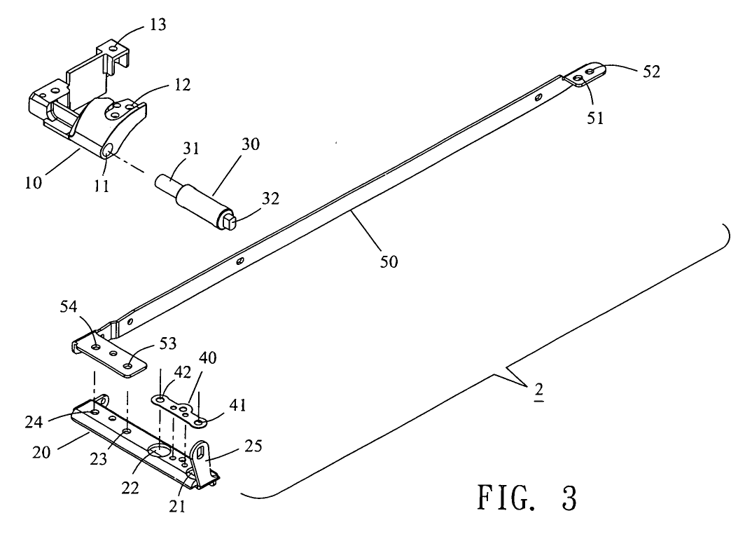

### DETAILED DESCRIPTION OF THE PREFERRED EMBODIMENT

Referring to FIGS. 1˜5, a pin-jointed structure 2 in accordance with the present invention is shown connected between a cover member 3 and a base member 4 of a mobile electronic device 1. The pin-jointed structure 2 enables the cover member 3 to be opened from and closed on the base member 4.

The pin-jointed structure 2 is comprised of a pivot holder 10, a mounting plate 20, a pivot member 30, a spring plate 40, and a bracket 50.

The pivot holder 10 has a pivot hole 11, and a plurality of mounting holes 12 and 13 fastened to the base member 4 with screws (not shown).

The mounting plate 20 has a first through hole 21, a second through hole 22, a first mounting hole 23, a second mounting hole 24, and an extension arm 25.

The pivot member 30 has a round pin 31 axially extending from its one end and pivotally coupled to the pivot hole 11 of the pivot holder 10, a locating pin 32 axially extending from its other end and affixed to the extension arm 25 of the mounting plate 20.

The spring plate 40 is fastened to the mounting plate 20 with screws or rivets (not shown), having a first mounting hole 41 and a second mounting hole 42.

The bracket 50 is adapted to support the LCD panel (not shown) of the cover member 3, having front mounting holes 51 and 52 on one end, namely, the front end, and a first rear mounting hole 53 and a second rear mounting hole 54 on the other end, namely, the rear end.

The first through hole 21 and second through hole 22 of the mounting plate 20 have a diameter greater than the first mounting hole 41 and second mounting hole 42 of the spring plate 40 such that a screw (not shown) is inserted through the first mounting hole 41 of the spring plate 40 and the first through hole 21 of the mounting plate 20 and fastened to a first boss 3a of the cover member 3, and a screw (not shown) is inserted through the second mounting hole 42 of the spring plate 40 and the second through hole 22 of the mounting plate 20 and fastened to a second boss 3b of the cover member 3.

The front mounting holes 51 and 52 of the bracket 50 are respectively affixed to one side of the cover member 3 with a respective screw (not shown). A screw (not shown) is inserted through the first rear mounting hole 53 of the bracket 50 and the first mounting hole 23 of the mounting plate 20 and fastened to a third boss 3c of the cover member 3 to secure the bracket 50 and the mounting plate 20 to the cover member 3. A screw (not shown) is inserted through the second rear mounting hole 54 of the bracket 50 and the second mounting hole 24 of the mounting plate 20 and fastened to a fourth boss 3d of the cover member 3 to secure the bracket 50 and the mounting plate 20 to the cover member 3.

Thus, the first boss 3a and second boss 3b of the cover member 3 are joined to the mounting plate 20 through the spring plate 40. When closing the cover member 3 on the base member 4 or opening the cover member 3 from the base member 4, the spring plate 40 is curved to disperse or buffer the drawing force between the pivot holder 10 and the mounting plate 20, avoiding concentration of stress and preventing breaking of the first boss 3a or second boss 3b of the cover member 3.

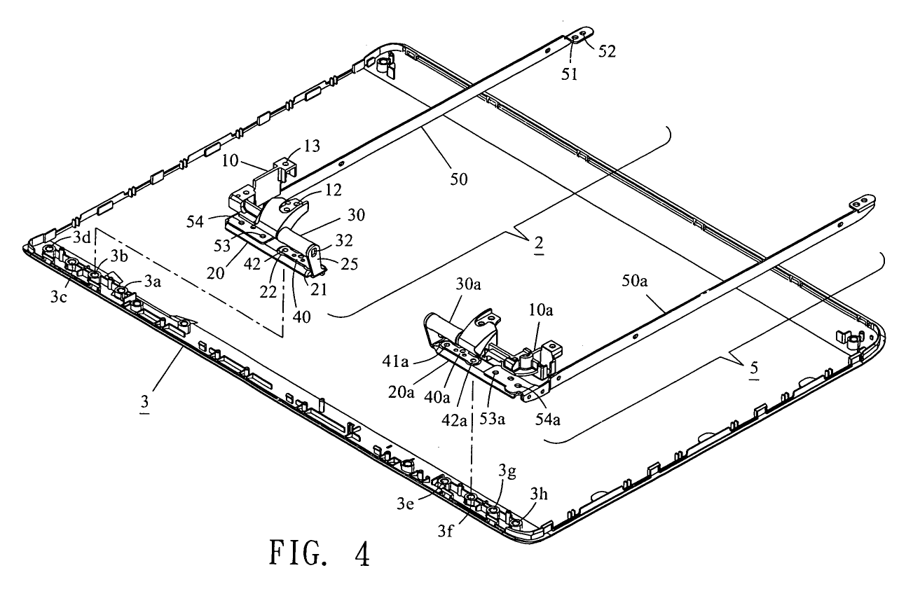

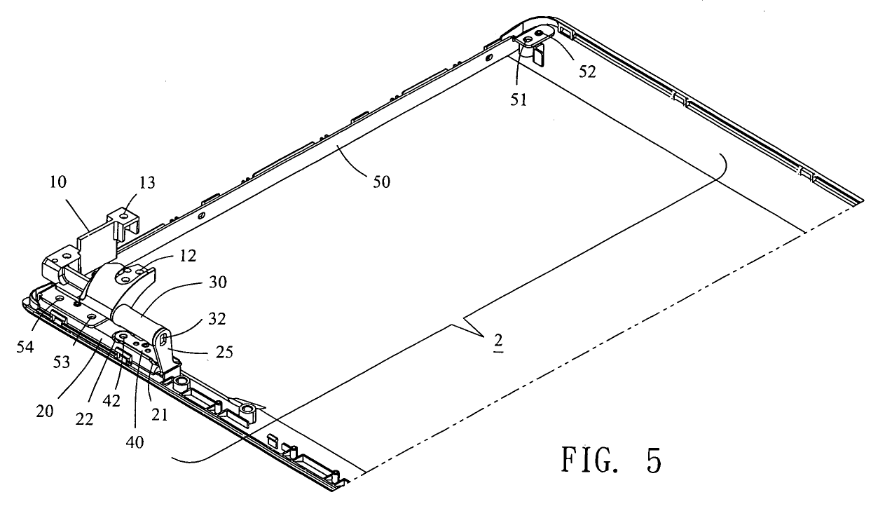

In actual application, as shown in FIG. 4, a second pin-jointed structure 5 is used and installed in the cover member 3 and the base member 4 at the other side opposite to the first pin-jointed structure 2, i.e., the two pin-jointed structures 2 and 5 are symmetrically installed in the cover member 3 and the base member 4 at two sides.

A screw (mot shown) is inserted through the first mounting hole 41a of the spring plate 40a and also inserted through the mounting plate 20a and then fastened to a corresponding boss 3e of the cover member 3; a screw (not shown) is inserted through the second mounting hole 42a of the spring plate 40a and also inserted through the mounting plate 20a and then fastened to a corresponding boss 3f of the cover member 3.

A screw (not shown) is inserted through the first rear mounting hole 53a of the bracket 50a and fastened to a corresponding boss 3g of the cover member 3; a screw (not shown) is inserted through the second rear mounting hole 54a of the bracket 50a and fastened to a corresponding boss 3h of the cover member 3.

Thus, when closing the cover member 3 on the base member 4 or opening the cover member 3 from the base member 4, the spring plate 40a is curved to disperse or buffer the drawing force between the pivot holder 10a and the mounting plate 20a, avoiding concentration of stress and preventing breaking of the boss 3e or 3f of the cover member 3.

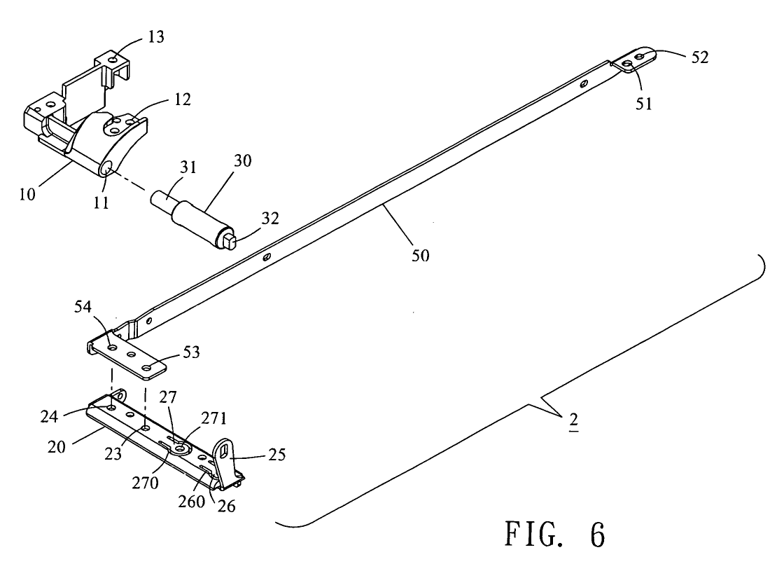

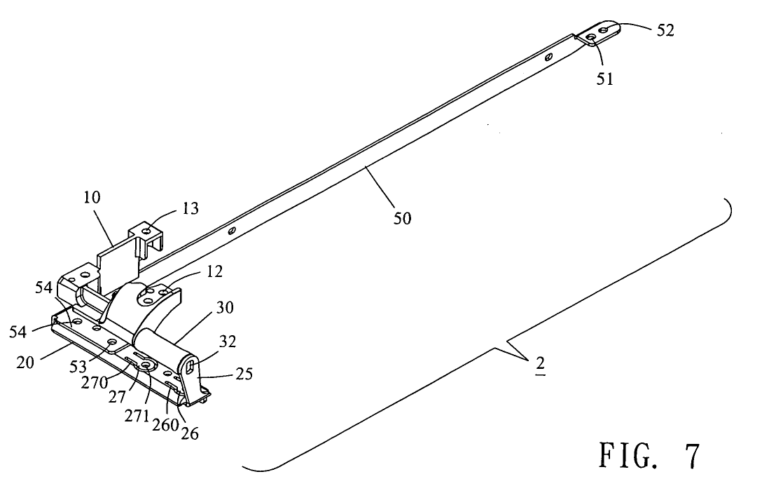

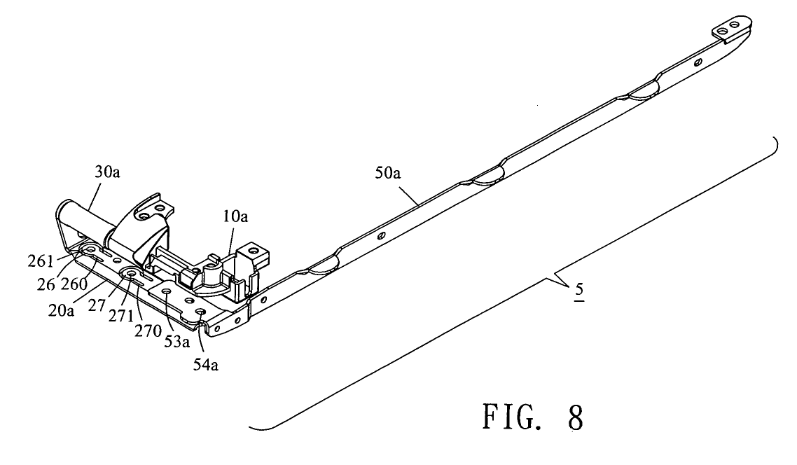

FIGS. 6 through 8 show a second embodiment of the present invention. According to this embodiment, the spring plates 40 and 40a of the two pin-jointed structures 2 and 5 are respectively formed integral with the respective mounting plates 20 and 20a, thereby simplifying the structure.

As illustrated, the mounting plate 20 or 20a is processed to provide two openings 260 and 270, thereby forming two spring plates, namely, the first spring plate 26 and the second spring plate 27. The mounting plate 20 or 20a further has a first mounting hole 23, a second mounting hole 24, and an extension arm 25. The first spring plate 26 has a mounting hole 261. The second spring plate 27 has a mounting hole 271. A screw (not shown) is inserted through the mounting hole 261 of the first spring plate 26 and fastened to a first boss 3a of the cover member 3. A screw (not shown) is inserted through the mounting hole 271 of the second spring plate 27 and fastened to a second boss 3b of the cover member 3.

When closing the cover member 3 on the base member 4 or opening the cover member 3 from the base member 4, the first spring plate 26 and the second spring plate 27 are curved to disperse or buffer the drawing force between the pivot holder 10 and the mounting plate 20, avoiding concentration of stress and preventing breaking of the first boss 3a or second boss 3b of the cover member 3. Further, the bracket 50 and the mounting plate 20 can be made in integrity. The bracket 50a and the mounting plate 20a can be made in integrity.

A prototype of pin-jointed structure has been constructed with the features of FIGS. 1˜8. The pin-jointed structure functions smoothly to provide all of the features disclosed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A pin-jointed structure connected between a cover member and a base member of a mobile electronic device for enabling said cover member to be opened from and closed on said base member, the pin-jointed structure comprising:
a pivot holder affixed to said base member;
a mounting plate affixed to said cover member and pivoted to said pivot holder with pivot means, said mounting plate having a first through hole; and
a spring plate mounted on said mounting plate, said spring plate having a first mounting hole for allowing insertion of a screw to be inserted through the first through hole of said mounting plate and fastened to a first boss of said cover member, the first mounting hole of said spring plate having a diameter smaller than the first through hole of said mounting plate.

2. The pin-jointed structure as claimed in claim 1, wherein said spring plate is affixed to said mounting plate with screws.

3. The pin-jointed structure as claimed in claim 1, wherein said spring plate is affixed to said mounting plate with rivets.

4. The pin-jointed structure as claimed in claim 1, wherein said mounting plate further has a second through hole; said spring plate further has a second mounting hole for allowing insertion of a screw to be inserted through the second through hole of said mounting plate and fastened to a second boss of said cover member, the second mounting hole of said spring plate having a diameter smaller than the second through hole of said mounting plate.

5. The pin-jointed structure as claimed in claim 1, further comprising a bracket fixedly fastened with said mounting plate to one side of said cover member.

6. The pin-jointed structure as claimed in claim 5, wherein said mounting plate further has a first mounting hole; said bracket has a first mounting hole formed on a rear end thereof and fastened with the first mounting hole of said mounting plate to a third boss of said cover member with a screw member.

7. The pin-jointed structure as claimed in claim 5, wherein said mounting plate further has a second mounting hole; said bracket further has a second mounting hole formed on the rear end thereof and fastened with the second mounting hole of said mounting plate to a fourth boss of said cover member.

8. The pin-jointed structure as claimed in claim 1, further comprising a bracket formed integral with a part of said mounting plate and affixed to one side of said cover member.

9. The pin-jointed structure as claimed in claim 1, which is arranged in pair between said cover member and said base member at two opposite lateral sides.

10. A pin-jointed structure connected between a cover member and a base member of a mobile electronic device for enabling said cover member to be opened from and closed on said base member, the pin-jointed structure comprising:
a pivot holder affixed to said base member; and
a mounting plate affixed to said cover member and pivoted to said pivot holder with pivot means, said mounting plate comprising a first spring plate formed integral with a part thereof, said first spring plate having a mounting hole for the insertion of a screw to be fastened to a first boss of said cover member.

11. The pin-jointed structure as claimed in claim 10, wherein said mounting plate has an opening in which said first spring plate suspends.

12. The pin-jointed structure as claimed in claim 10, wherein said mounting plate further comprises a second spring plate formed integral with a part thereof, said second spring plate having a mounting hole for the insertion of a screw to be fastened to a second boss of said cover member.

13. The pin-jointed structure as claimed in claim 12, wherein said mounting plate has an opening in which said second spring plate suspends.

14. The pin-jointed structure as claimed in claim 10, further comprising a bracket affixed with said mounting plate to one side of said cover member.

15. The pin-jointed structure as claimed in claim 10, wherein said mounting plate further has a first mounting hole; said bracket has a first mounting hole formed on a rear end thereof and fastened with the first mounting hole of said mounting plate to a third boss of said cover member with a screw member.

16. The pin-jointed structure as claimed in claim 14, wherein said mounting plate further has a second mounting hole; said bracket further has a second mounting hole formed on the rear end thereof and fastened with the second mounting hole of said mounting plate to a fourth boss of said cover member.

17. The pin-jointed structure as claimed in claim 10, further comprising a bracket formed integral with a part of said mounting plate and affixed to one side of said cover member.

18. The pin-jointed structure as claimed in claim 10, which is arranged in pair between said cover member and said base member at two opposite lateral sides.
